(19) United States
(12) Patent Application Publication
(10) Pub. No.: US 2015/0282687 A1
(43) Pub. Date: Oct. 8, 2015

(54) CELLULOSE SPONGE AND METHOD FOR THE SAME

(71) Applicant: Haion Won, Basking Ridge, NJ (US)

(72) Inventor: Haion Won, Basking Ridge, NJ (US)

(21) Appl. No.: 14/245,089

(22) Filed: Apr. 4, 2014

(51) Int. Cl. A47L 13/17; B32B 37/14; C11D 11/00; B32B 23/00; C11D 17/04; A47L 17/00; B29C 65/48

(52) U.S. Cl. CPC A47L 13/17; A47L 17/00; B32B 37/14; B29C 65/48; B32B 23/00; C11D 17/046; C11D 11/0023; B29L 2009/00

(57) ABSTRACT

A cellulose sponge comprised of a cellulose pad having a first surface onto which is attached one or more detergent coins or detergent liquid balls and a method for the same. The cellulose pad has a second surface onto which is attached a scouring pad.

### BACKGROUND

1. Field

The present invention relates to a sponge. In particular the present invention relates to a cellulose sponge e.g. a sponge made of cellulose material that can dispense detergent fluid for cleaning method for the same. The cellulose sponge of the present invention has a cellulose pad with a surface onto which is disposed and attached detergent coins or detergent balls, the sponge has another surface that is attached a scouring pad to assist in the cleaning process by the sponge.

2. The Related Prior Art

Sponges are used for cleaning and typically employ soap or liquid detergent for cleaning dishes silverware, pots and pans. It would be desirable to provide a sponge preferably a disposable sponge that can be made with a sponge material and have a layer of a scouring pad attached to thereto. It would be further desirable to provide a sponge capable of dispensing detergent from the sponge during the cleaning process. In this manner the sponge could be self contained detergent containing sponge with a scouring pad that can wash, dispense detergent fluid and also scour the surface of the item that is being cleaned.

### SUMMARY

The present invention provides a cellulose sponge comprised of a cellulose pad having a first surface onto which is attached one or more detergent coins or detergent liquid balls and a method for the same. The cellulose pad has a second surface onto which is attached a scouring pad.

### BRIEF DESCRIPTION OF THE DRAWINGS

FIG. 1 is a front view of the present invention that illustrates detergent capsules attached to a surface of the cellulose sponge pad;

FIG. 2 is a side view of the present invention showing a first embodiment wherein the detergent capsules in FIG. 1 are detergent coins attached to the first surface of the cellulose pad;

FIG. 3 is a side view of the present invention showing a second embodiment wherein the detergent capsules in FIG. 1 are detergent liquid balls attached to the first surface of the cellulose pad;

FIG. 4 is a front view of the scouring pad that is to be attached to the cellulose pad of FIG. 1 in accordance with the teachings of the present invention;

FIG. 5 is a side view of the scouring pad of FIG. 4;

FIG. 6 is a partially exploded perspective view of the first embodiment of the present invention; and

FIG. 7 is a partially exploded perspective view of the second embodiment of the present invention.

### DETAILED DESCRIPTION OF THE PREFERRED EMBODIMENTS

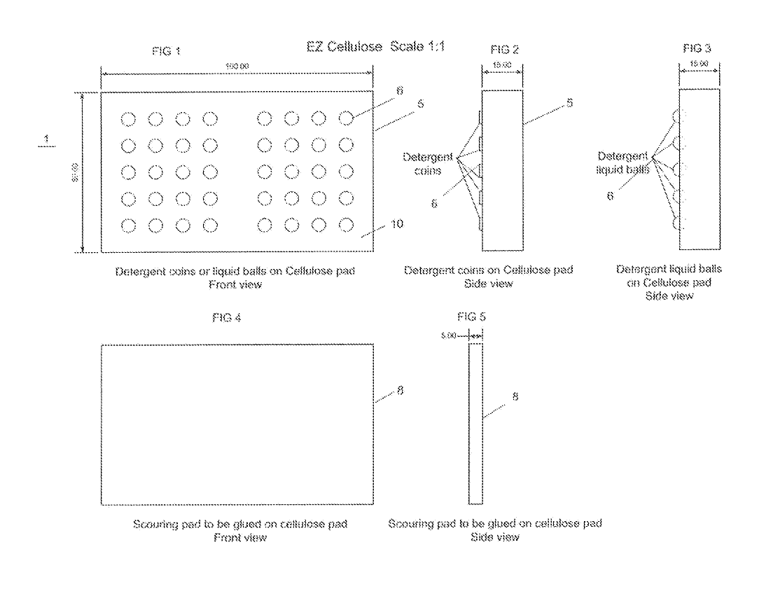

Referring now to the drawings of FIGS. 1-7, FIG. 1 illustrates a cellulose sponge 1 according to the present invention in which detergent capsules are attached to a first surface of the cellulose pad detergent capsules 6 attached to a first surface 10 of the cellulose sponge pad 5. The detergent capsules are attached to the first surface 10 of the cellulose pad 5 by adhesive material such as but not limited to glue 7 or other adhesive substance 7 preferably liquid that can be placed onto the first surface 10 of the cellulose sponge 5. The detergent capsules can be detergent coins 6 (FIG. 2) or detergent liquid balls 6. The detergent coins 6 are preferably powdered pressed and molded using any commercially available dishwashing detergent or small soap bars 6. It is understood that the present invention is not limited to these detergent coins 6 being coin shaped but that they can have any one of a variety of shapes. The detergent liquid balls 6 of FIG. 3 are formed of polyvinyl material such as but not limited to materials used in plastic bags and contain liquid detergent inside of each of the balls 6. Again the present invention is not limited to the shape of balls 6 for these detergent dispensing capsules 6 of FIG. 3 and can have any desired shape or form.

The scouring pad 8 is formed of any commercially known scouring pad and it is attached to a second surface 11 of said cellulose pad 5 of preferably adhesive material 7 that can be applied to the second surface of the cellulose pad 5 or the attaching surface of the 13 of the scouring pad 8 or both surfaces. Alternatively, a double sided adhesive tape can be used to attach the scouring pad 8 to the second surface of the cellulose pad 5. The exposed, non attached surface of the scouring pad has textured scouring portions 9 for scouring during the cleaning process.

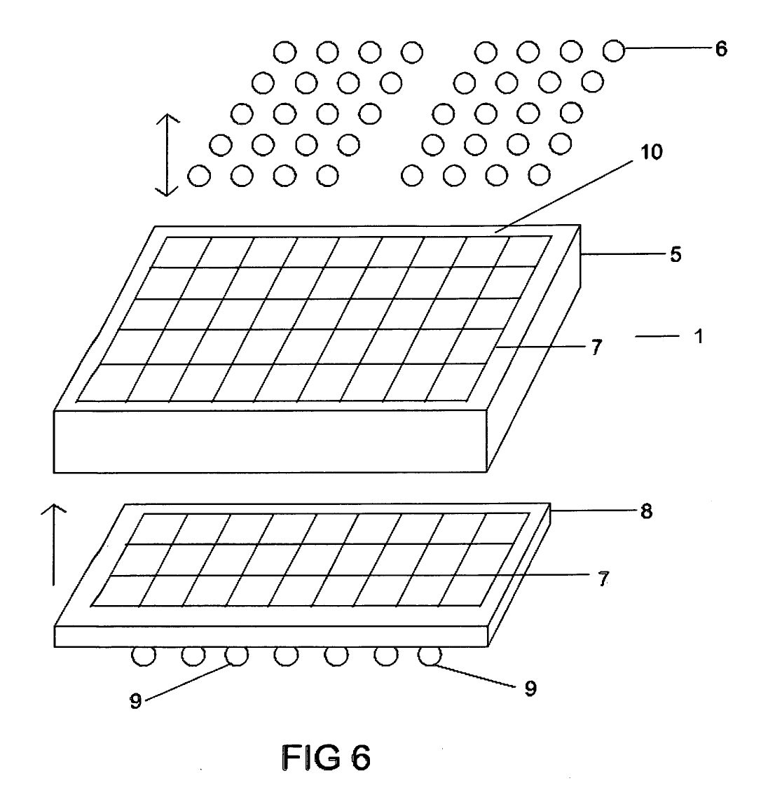

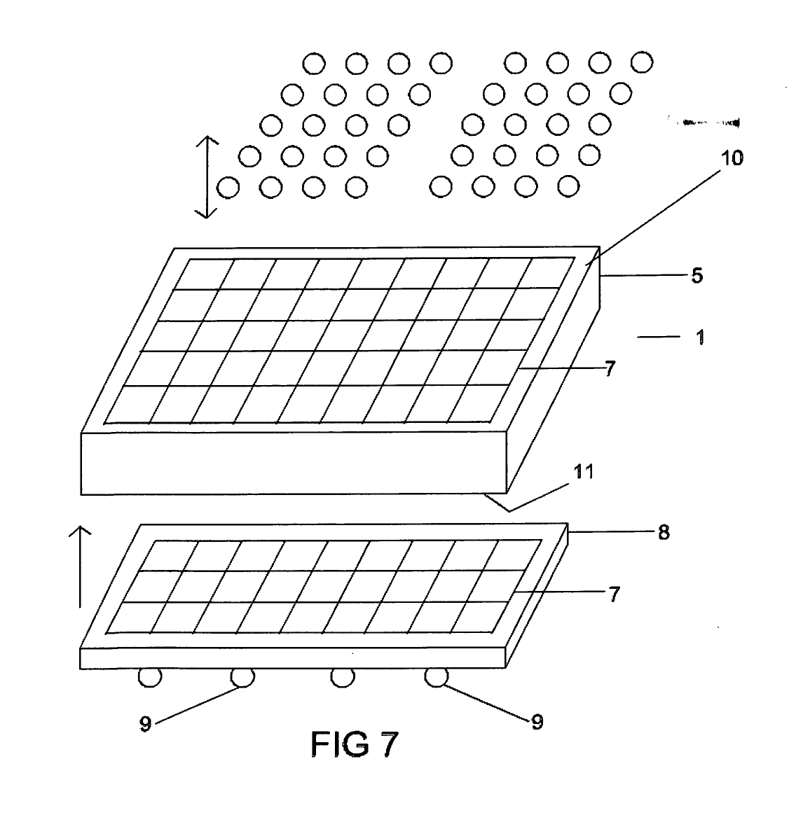

FIGS. 6 and 7 illustrate the method of forming the two embodiments of the present invention. In FIG. 6 a set of detergent coins or otherwise shaped detergent capsules 6 can be attached adhesively or otherwise as commercially known to a first surface of a cellulose pad 5. The adhesive material 7 can be disposed on the first surface of the cellulose pad 5 and the detergent capsules or coins disposed thereon, preferably in a symmetric pattern to insure adequate dispensing of detergent product during the cleaning process throughout the surface of the cellulose pad sponge 5. The scouring pad can be attached preferably by adhesive substance on the surface or surfaces of the scouring pad's attaching surface or the second surface 11 of the cellulose pad or by a double, adhesive tape securing the second surface of the cellulose pad 5 to the attaching surface of the scouring pad 8. The scouring pad 8 on its bottom non attached, exposed surface has textured scouring particles 9 for scouring during the cleaning process. The scouring pad can be made from any commercially known scouring material. In operation when the cellulose sponge is wet the detergent capsules of coins which can be small soap bars become wet and dispense detergent or soap when the sponge is applied to a surface to be cleaned. The scouring pad can be used to scour the dirt and grime of the surface to be cleaned.

FIG. 7 illustrates the second embodiment in which balls of preferably polyvinyl material such as but not limited to the materials used in plastic bags each contain a detergent liquid. These balls or otherwise shaped capsules of polyvinyl material containing detergent liquid are again attached adhesively or otherwise as commercially known to a first surface of a cellulose pad 5. The adhesive material 7 can be disposed on the first surface of the cellulose pad 5 and the detergent liquid capsules or balls disposed thereon preferably in a symmetric pattern to insure adequate dispensing of liquid detergent product during the cleaning process throughout the surface of the cellulose pad sponge 5. The scouring pad can be attached preferably by adhesive substance on the surface or surfaces of the scouring pad's attaching surface or the second surface 11 of the cellulose pad or by a double, adhesive tape securing the second surface of the cellulose pad 5 to the attaching surface of the scouring pad 8. The scouring pad 8 on its bottom non attached, exposed surface has textured scouring particles 9 for scouring during the cleaning process. The scouring pad can be made from any commercially known scouring material. In operation when the cellulose sponge is wet, the detergent capsules or balls of the polyvinyl material is wet and the detergent liquid is dispensed through the polyvinyl material when the sponge is applied to a surface to be cleaned. The scouring pad can be used to scour the dirt and grime of the surface to be cleaned.

While certain embodiments have been shown and described, it is distinctly understood that the invention is not limited thereto but may be otherwise embodied within the scope of the appended claims.

What is claimed:

1. A cellulose sponge, comprising:
A sponge including cellulose pad having a first surface;
one or more detergent capsules being attached onto said first surface of said cellulose pad adapted to dispense detergent material when said sponge is applied to a surface to be cleaned.

2. The cellulose sponge further comprising:
said cellulose pad having a second surface onto which is attached a scouring pad adapted to scour said surface to be cleaned.

3. The cellulose sponge according to claim 1 wherein said detergent capsule is formed powdered pressed and molded powdered dishwashing detergent.

4. The cellulose sponge according to claim 1 wherein said detergent capsules are formed as small soap bars.

5. The cellulose sponge according to claim 1 wherein said capsules are balls of polyvinyl material each containing liquid dishwashing detergent.

6. The cellulose sponge according to claim 1 wherein said one or more capsules are a plurality of capsules.

7. The cellulose sponge according to claim 1 wherein said capsules are attached to the cellulose pad by adhesive material.

8. The sponge according to claim 1 wherein the adhesive material is adhesive liquid substance applied to the first surface of the cellulose pad.

9. A method of forming a cellulose sponge, the steps comprising:
Providing a sponge including a cellulose pad having a first surface;
Attaching one or more detergent capsules being attached onto said first surface of said cellulose pad adapted to dispense detergent material when said sponge is applied to a surface to be cleaned.

10. The method according to claim 9 sponge further comprising:
Attaching a scouring pad to a second surface of said cellulose pad said scouring pad being adapted to scour said surface to be cleaned.

11. The method according to claim 9 wherein said detergent capsules are formed powdered pressed and molded powdered dishwashing detergent.

12. The method according to claim 9 wherein said detergent capsules are formed as small soap bars.

13. The method according to claim 9 wherein said capsules are balls of polyvinyl material each containing liquid dishwashing detergent.

14. The method according to claim 9 wherein said one or more capsules are a plurality of capsules.

15. The method according to claim 9 wherein said capsules are attached to the cellulose pad by adhesive material.

16. The method according to claim 9 wherein the adhesive material is adhesive liquid substance applied to the first surface of the cellulose pad.
